(19) United States
(12) Patent Application Publication
(10) Pub. No.: US 2018/0269559 A1
(43) Pub. Date: Sep. 20, 2018

(54) RADOME PROVIDED WITH A RESISTIVE HEATING SYSTEM FORMED FROM STRIPS OF METAL NANOELEMENTS

(71) Applicant: COMMISSARIAT À L'ÉNERGIE ATOMIQUE ET AUX ÉNERGIES ALTERNATIVES, Paris (FR)

(72) Inventors: Caroline Celle, Firminy (FR); Laurent Dussopt, Grenoble (FR); Jean-Pierre Simonato, Sassenage (FR)

(21) Appl. No.: 15/758,469

(22) PCT Filed: Sep. 8, 2016
(86) PCT No.: PCT/EP2016/071205

§ 371 Date: Mar. 8, 2018

(30) Foreign Application Priority Data
Sep. 11, 2015 (FR) 15 58498

(51) Int. Cl. H01Q 1/02; H01Q 1/42; H01Q 1/32; H05B 3/12; H05B 3/26

(52) U.S. Cl. CPC H01Q 1/02; H01Q 1/425; H01Q 1/3233; H05B 3/12; H05B 2214/04; H05B 2203/005; H05B 2203/013; H05B 2203/034; H05B 2214/02; H05B 3/267

(57) ABSTRACT

A radome (4) intended for protecting an antenna capable of radiating and/or picking up radio waves in a given range of frequencies from 3 MHz to 300 GHz, the radome being provided with a heating system (10) which includes two electric contacts (14, 16) between which are arranged resistive heating elements (12) in the form of parallel strips spaced apart from one another and each having two ends respectively connected to the two electric contacts (14, 16), each of the strips (12) being made from a network of nanoelements comprising metal nanowires (18).

### TECHNICAL FIELD

The present invention relates to the field of radomes for protecting an antenna capable of radiating and/or sensing radio waves in a given frequency range ranging from 3 MHz to 300 GHz. Preferentially, these radomes are intended to antennas radiating/sensing super high frequency (from 3 GHz to 30 GHz) or extremely high frequencies (from 30 to 300 GHz) waves.

The invention relates in particular to the heating system integrated to the radome, provided for defrosting and/or demisting the same.

The invention finds particular applications in the automotive, telecommunications, military, and aeronautic fields.

### STATE OF PRIOR ART

Frost that builds up on a radome can degrade the operation of the system with which it is associated. Indeed, frost filters radio waves passing therethrough and thus limits the transparency of the radome to the same waves. In this regard, it is noted that the detection distance of a radar is directly correlated with the transparency of the radome to the radio waves. Thus, under some circumstances, the detection distance of a sensor can turn out to be so lowered by the presence of frost that the sensor has to be deactivated.

Solutions for heating the radome have thus been proposed, so as to enable it to be defrosted and thus the operating range of the associated system to be extended. Many techniques enable such heating to be ensured, such as resistive heating enabling frost to be removed by the Joule effect. However, this technique faces the problem of preserving transparency of the radome to the waves in question.

Till now, no solution enabled to result in a resistive heating with a sufficient intensity, while preserving the required transparency to radio waves.

### DISCLOSURE OF THE INVENTION

To overcome at least partially the abovementioned drawbacks, one object of the invention is first to provide a radome for protecting an antenna capable of radiating and/or sensing radio waves in a given frequency range ranging from 3 MHz to 300 GHz, said radome being equipped with a heating system comprising two electrical contacts in which resistive heating elements are arranged.

According to the invention, said resistive heating elements are parallel strips spaced apart from one another and each having two ends respectively connected to both electrical contacts, each of the strips being made using a network of nanoelements including metal nanowires. In addition, the strips have a first width (L1) strictly lower than half the length (λ) of the radio wave radiated/sensed by the antenna, and the period (P) at which the strips succeed each other is substantially equal to the product n·λ, with (n) corresponding to a positive integer preferably different from 1.

Surprisingly, structuring the heating system as strips of metal nanowires enables a high performance resistive heating to be achieved for defrosting the radome, while preserving a high transparency level to the radio waves in question. In addition since these nanoelements have high transparency properties in the visible spectrum, the invention can advantageously be applied to semi-transparent radomes without altering too significantly the optical transparency properties of this radome.

Finally, the invention can be easily implemented using controlled and low cost techniques perfectly suitable for structuring in strips on a planar or more complex shaped support. By way of example, depositing nanoelements can be made by low temperature, high flow rate spraying, which technology is widely controlled in particular in the automotive field.

The invention has preferably at least one of the optional following characteristics, taken alone or in combination.

The radome has a transparency to radio waves, in said given range, higher than 50%, and more preferentially higher than 70%.

Further, in order to preserve optical transparency properties, the radome has an overall transmittance higher than 60% in the visible spectrum, and more preferentially between 70 and 90%.

Preferably, said nanoelements are based on silver and/or copper and/or nickel and/or gold.

Preferably, the strips have a first width L1 identical for each strip, and in they are separated by inter-strip zones having a second width L2 identical for each inter-strip zone, the ratio of the second width L2 to the first width L1 being higher than or equal to 1. However, the width of the strips could differ from one strip to the other, without departing from the scope of the invention. The same is true for the inter-strip zones.

Preferably, the first width L1 is between 0.5 and 3 mm, and more preferentially in the order of 2 mm.

Preferably, the second width L2 is between 4 and 10 mm.

According to a first exemplary embodiment:
each strip has an electric resistance between 3 and 4Ω;
the first width L1 is about 2 mm; and
the second width L2 is about 2 mm.

This first embodiment turns out to be perfectly suitable for many applications, in particular in the telecommunications field with antennas operating at 60 GHz.

According to a second exemplary embodiment:
each strip has an electric resistance between 8 and 10Ω;
the first width L1 is about 2 mm; and
the second width L2 is between 4 and 6 mm.

This second embodiment turns out to be perfectly suitable for many applications, in particular in the automotive field and in ACC (Auto Cruise Control) applications, implementing high distance detection sensors integrating antennas operating at 77 GHz.

Preferably, the radome has a main structure on which the heating system is deposited, said main structure having an intrinsic transparency to radio waves, in said given range, higher than 70%.

Preferably, the main structure is made of poly(ethylene naphthalate) or in acrylonitrile butadiene styrene, even if other plastic materials can be contemplated, without departing from the scope of the invention.

Preferably, the radome is coated with an anti-scratch and/or heat conduction layer.

One object of the invention is also an assembly comprising an antenna capable of radiating and/or sensing radio waves in a given frequency range ranging from 3 MHz to 300 GHz, and a radome as described above.

Preferably, for a better transparency to the waves, the radome is arranged such that its strips are parallel to the direction of polarisation of the antenna.

Depending on the application contemplated, the antenna is preferentially designed to radiate and/or sense radio waves of 24 GHz, 60 GHz or 77 GHz. Other frequencies or frequency ranges are of course contemplatable, without departing from the scope of the invention.

Further advantages and characteristics of the invention will appear in the detailed non-limiting description below.

### BRIEF DESCRIPTION OF THE DRAWINGS

This description will be made with regard to the appended drawings in which:

FIG. 1 represents a schematic view of an assembly according to the invention, for example of the high distance detection sensor type;

FIG. 2 represents a front view of the radome equipping the assembly shown in FIG. 1;

FIG. 3 is a schematic view showing the strips of nanoelements of the radome, which are disposed in parallel to the direction of polarisation of the antenna.

### DETAILED DESCRIPTION OF PREFERRED EMBODIMENTS

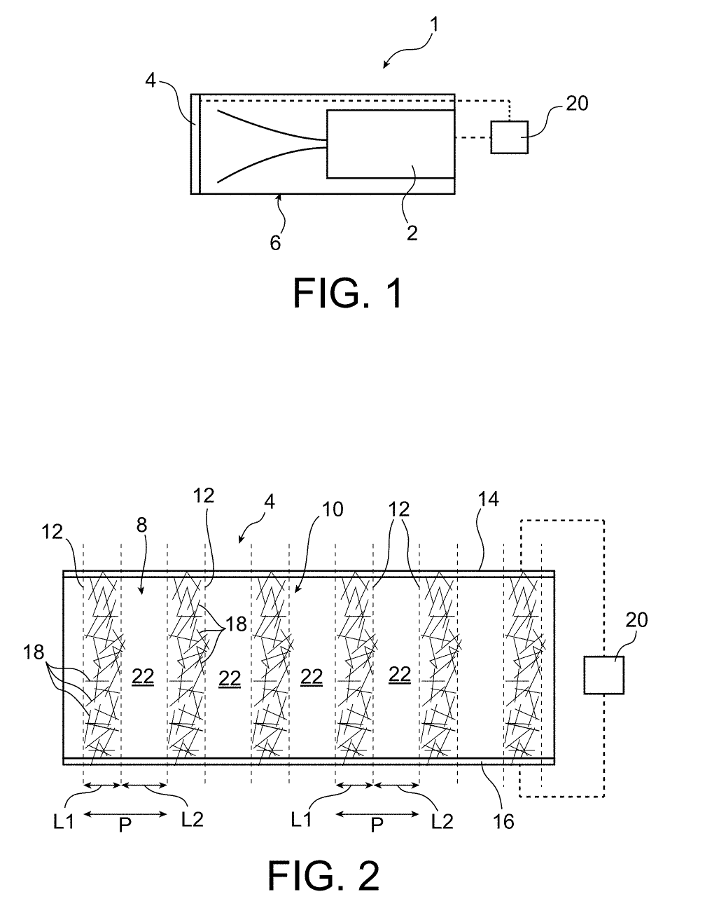

First in reference to FIG. 1, an assembly 1 according to a preferred embodiment of the invention is represented. This assembly 1 is a system dedicated to the telecommunications field, and includes an antenna 2 operating at a frequency of 60 GHz, as well as a radome 4 protecting this antenna. The terrestrial telecommunications networks actually use a great number of point to point links (microwave beam systems) for transmitting communications on long distances, or interconnecting different parts of a same network. The antennas of these links are generally disposed on culminating points (towers, buildings, mountains) and thus naturally exposed to bad weather including freezing and snow. The Typical bands used are 30-45 GHz, 57-66 GHz and 71-86 GHz.

However, other applications are possible, for example a high distance detection sensor for the automotive field, in which the antenna operates at a frequency in the order of 77 GHz. Still in the automotive field, the assembly 1 could be a proximity sensor, with an antenna operating at a frequency of 24 GHz.

However, the invention covers any assembly 1 comprising an antenna and its radome, with the antenna capable of radiating and/or sensing radio waves in a given frequency range ranging from 3 MHz to 300 GHz. The favoured application fields are the automotive, military and aeronautics fields.

In reference now to FIG. 2, the radome 4 which forms a part of the external casing 6 of the assembly 1 is represented.

The radome 4 is herein planar, but could have a more complex shape, for example with a single or double curvature. It includes a main plastic structure 8, having an intrinsic transparency to the radio waves in question, which is higher than 70%. Conventionally, this transparency corresponds to the transmitted radiation percentage, defined by the ratio of transmitted power to incident power. The transparency to radio waves of the main structure can reach very high values, depending on the nature of the material. For example, a structure 8 of ABS (acrylonitrile butadiene styrene), with a 3 mm thickness, has a transparency to radio waves in the order of 72%. A structure 8 of PEN (poly(ethylene naphthalate)), with a 125 μm thickness, has a transparency to radio waves reaching 98%.

Other materials are contemplatable for the structure 8, for example poly(ethylene naphthalate), KAPTON® polyimide, polycarbonate, PMMA (PolyMethylMethAcrylate), ASA (Acrylonytrile Styrene Acrylate) copolymer, PE (PolyEthylene), PP (PolyPropylene), PES.

The thickness of the main structure 8 is adapted optimally in order to optimise the transparency to radio waves. It is typically in the order of 1 to 3 mm, but could of course be lower as for the example of PEN described below. Generally, decreasing the thickness of the structure enables the transparency to radio waves to be increased.

One of the features of the invention lies in the presence of a heating system 10 equipping the main structure 8 of the radome. This is a system comprising resistive heating elements forming strips 12 spaced apart from one another, and parallel to each other. In this regard, it is indicated that when the structure 8 is not planar, the parallelism between the strips 12 is characterised by the parallelism of the planes containing each of these strips.

The strips 12 have a first width L1, identical for all the strips. These also have a same length for example between 2 and 20 cm, and preferably between 5 and 15 cm, as well as a same thickness which is for example between 100 and 50 000 nm. The strips 12 are each made using a network of nanoelements 18 comprising metal nanowires. By nanowires, it is meant elements the ratio of length to diameter of which is higher than 10, and the diameter of which can range from 20 to 800 nm.

These metal nanowires 18 are preferably made using an Ag, Au, Ni or Cu type metal, or using a material containing at least 50% of one of the aforesaid metals. Metal nanowires made in different materials taken from the abovementioned group can be mixed within the network deposited onto the structure 8, without departing from the scope of the invention.

On the other hand, other types of nanoelements can also be integrated therein, such as carbon nanotubes and/or derivatives of these type of nanotubes, graphene sheets and/or derivatives of this type of material, and/or even nanoelements based on boron nitride or metal oxides, for example of the hexagonal boron nitride (h-BN), ZnO or SiO2 type.

The nanoelements 18 form a percolating area network deposited at the surface of the substrate forming main structure 8. Its area density can be in the order of 10 to 100 mg/m², and more preferentially in the order of 20 to 70 mg/m².

At two opposite ends of each strip 12, there are respectively an input electrical contact 14 and an output electrical contact 16, each made using a fine copper blade or silver paste. These contacts 14, 16 have linear resistances widely lower than those of the strips 12, in order to ensure resistive heating in the network of metal nanowires 18. They are for example of the metal film type, obtained by evaporation or spraying Ti/Au, Cr/Au, Cr/Alu. The deposition can also be made using a lacquer, for example a silver lacquer, or even using electrically conductive adhesives.

The electrical contacts 14, 16 enable an electrical voltage to be applied to the networks 18 forming resistive heating elements. This voltage is delivered by a suitable apparatus 20, optionally adapted for powering the antenna 2, as has been schematically represented in FIG. 1. The power supply voltages contemplated are between 1 and 20V, and preferentially between 1 and 12V.

The equivalent resistance formed by all the strips 12 of the heating system 10 is for example between 5 and 250 ohm.

The strips 12 are spaced apart from one another by inter-strip zones 22 on which the main structure 8 is left free, that is without deposition of nanowires 18. These zones 22 have a second width L2 identical for all the zones, and higher than or equal to the first width L1 of the strips 12. The ratio of both widths L1 and L2 is thus preferably higher than or equal to 1. The sum of both widths L1 and L2 corresponds to the period P at which the strips 12 succeed each other on the main structure 8.

Preferably, the first width L1 is between 0.5 and 3 mm, and even preferentially in the order of 2 mm, whereas the second width L2 is preferentially between 2 and 8 mm.

The dimensions L1 and P are chosen in connection with the wavelength of the incident signal. The latter is defined the following way λ=c/f, c being the light velocity (299 792 458 m·s⁻¹) and f the wave frequency (in Hz). By way of example, the associated wavelength is 3.9 mm for operating frequencies of 77 GHz, or even 12.5 mm for operating frequencies of 24 GHz.

The first width L1 of the strips 12 of silver nanowires is defined as low as possible, for example 0.5 mm, and the maximum value of which is in the order of λ/2, that is typically about 2 mm at 77 GHz. The period P can be substantially equal to a multiple of λ, that is typically about 4, 8 or 12 mm at 77 GHz. Thus, P is such that it is substantially equal to the product n·λ, with n corresponding to a positive integer different from 1. By way of information, a margin within 10% remains perfectly admissible between the value of P and the value of the product n·λ.

The deposition of the strips of nanowires 18 is made conventionally. The nanowires can for example be deposited at a high flow rate and low temperature using a spray and a stencil masking the inter-strip zones 22. Alternatively, the deposition of nanowires can be made on the entire surface of the structure 8, to be then structured in order to make the strips 12 appear by removing the nanowires at the inter-strip zones 22. This removal can be made by ablation (solution etching or laser shot). The technique of deposition by vaporisation is also contemplated, without departing from the scope of the invention.

The nanowires 18 are in turn obtained beforehand conventionally. For example, copper nanowires can be synthetised according to the technique disclosed in the publication Nano Research 2014, 7(3): 315-324. For silver nanowires, they can be prepared according to the operating mode described in the publication Nanotechnology 2013, 24, 215501.

The structure 8, equipped with its strips 12 of metal nanowires 18, can be coated with an anti-scratch protective layer (non visible in FIG. 2), and/or a heat conduction layer to diffuse at best the heat produced by Joule effect on the entire surface of the radome. This layer can be of the polymer, resin, varnish type or the like, or even an adhesive film. For example, this can be a PSA barrier adhesive laminated on the structure 8, or even a polyurethane PU varnish applied by spraying onto this structure.

Depending on the application contemplated, the radome 4 can have optical semi-transparency properties, with a transmittance higher than 60% in the visible region, that is for wavelengths ranging from 390 to 780 nm. This transmittance, also called transmission factor or transparency, can however be higher for the radome 4, for example between 70 and 90%. This very high transmittance range can be achieved by judiciously choosing the material of the structure 8, its thickness, as well as judiciously setting the widths L1 and L2. This enables the radome 4 to preserve its optical semi-transparency functions, when such a function is desired.

Further, the radome equipped with strips 12 have an overall transparency to the radio waves in question, being higher than 70%. Surprisingly, the simple structuring in strips or in “rake teeth” of the resistive elements actually enables a high transparency to radio waves to be achieved, while providing a satisfactory heating to generate defrosting or demisting. This effect is all the more surprising that when the entire surface of the structure 8 is coated with nanowires, the transparency to radio waves does not exceed 25%, even by lowering the density of these nanowires to very low values. This transparency level turns out to be quite insufficient to enable the associated system to properly work, and the low nanowire density resulting in this transparency level does not enable suitable temperatures to be achieved anyway to ensure a proper radome defrosting.

Tests highlighting these conclusions have been performed, and the results of these tests are listed in the table herein below. In this table, the first column represents the area electric resistance of the nanowire layers, this resistance being inversely proportional to the nanowire density within the layer. The second column corresponds to the transmittance for a wavelength of 550 nm. The transparence to radio waves (RF transparency) is the object of the third column, for waves emitted at 60 GHz. Finally, the fourth column sets forth the temperature obtained at the radome surface.

| | | | Temperature |
|---|---|---|---|
| Area resistance | Transmittance | RF transparency | obtained |
| (Ω/square) | (at 550 nm) (%) | (at 60 GHz) (%) | (at 12 V) (° C.) |
| 20 | 80 | 1 | 68 |
| 66 | 90 | 7 | 55 |
| 210 | 93 | 18 | 38 |
| 724 | 95 | 24 | 28 |

These tests, which lead in no way to predict that a particular structuring of the layer of metal nanowires can result both to a satisfactory resistive heating, and a high RF transparency, have been made under the following conditions.

A. Synthesis of Silver Metal Nanowires

The manufacture of silver nanowires in solution is made according to the following method:

1.766 g of PVP (polyvinylpyrrolidone) are added to 2.6 mg of NaCl (sodium chloride) in 40 ml EG (ethyleneglycol). The mixture is stirred at 600 rpm (rotations per minute) at 120° C., until the PVP and NaCl are completely dissolved (about 4-5 minutes). This mixture is then dropwise added to an ethylene Glycol (“EG”) solution of 40 ml in which 0.68 g of AgNO3 (silver nitrate) are dissolved. The oil bath is then heated at 160° C. and stirring at 700 rpm is carried out for 80 minutes. Three washings are made with methanol by centrifuging at 2 000 rpm for 20 min, and then the nanowires are precipitated with acetone, and then redispersed in water or methanol.

B. Printing the Strips and Electrical Contacts

The substrate chosen is a 10×10 cm 125 μm PEN substrate. This substrate corresponds to the main structure of the radome. The substrate has herein an intrinsic RF transparency of 98%, for waves generated at 60 GHz by the antenna.

The electrical contacts consist of a Au 150 nm deposition, made by sputtering before printing the strips of nanowires.

The manufacture of strips is in turn made by full plate spraying of a network of silver nanowires, <00.10.23> of a 0.5 g/L methanol solution of metal nanowires. This step can be made using a Sonotek© spray. Four samples having increasing nanowire densities are prepared.

The protective layer of the radome consists of a PSA barrier adhesive laminated on the sample.

C. Transparency of the Radome

The transmittance and RF transparency performance is given in columns 2 and 3 of the table above. The results enabled previously set out conclusions to be drawn.

D. Heating by Joule Effect

The ambient temperature during the measurements is 25° C. The temperatures given in the fourth column are measured after 2 minutes of stabilization at the voltage applied, herein 12V. The heating rate are in the order of 1° C./s.

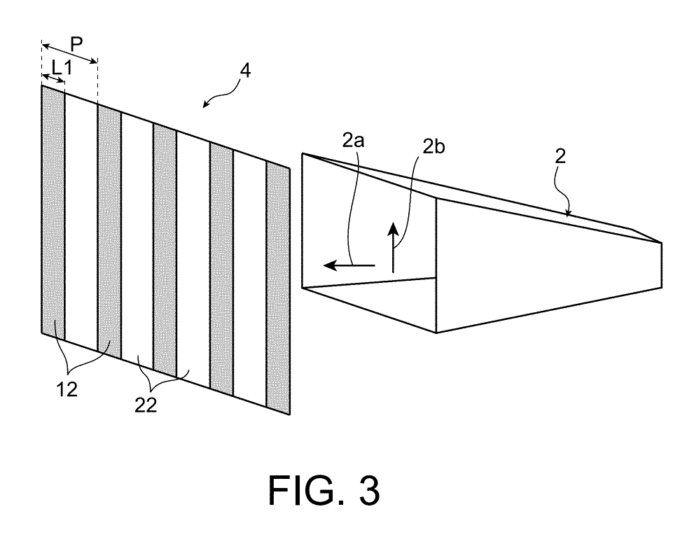

Now, two exemplary embodiments of the invention may be described. These two examples have been made with the strips 12 oriented in parallel to the polarisation of the antenna, as is visible in FIG. 3. On the same, the single linear polarisation antenna 2, the direction of propagation of the wave 2a, and the direction of polarisation of the antenna 2b are represented. The strips 12 are parallel to the direction of polarisation 2b.

### Example 1

The first example turns out to be perfectly suitable for the telecommunications field, with antenna operating at about 60 GHz. The operating conditions are identical to those mentioned above in points A to D, with the following provisos:
the RF transparency is investigated at 66 GHz.
strips of nanowires are made with a first width L1 of 2 mm, and the inter-strip zones are first set with a second width L2 of 2 mm (resulting in a period P of 4 mm), and then the second width is set to 6 mm (resulting in a period P of 8 mm).

The results of these tests are given in the table below.

| Strip | Widths | | | |
|---|---|---|---|---|
| resistance | L1-L2 | Period P | RF transparency | Temperature |
| (Ω) | (mm-mm) | (mm) | (at 66 GHz) (%) | obtained (° C.) |
| 3.5 | 2-2 | 4 | 98 | 44 (at 5 V) |
| 5.2 | 2-6 | 8 | 96 | 40 (at 6 V) |

In this first example, the area electric resistance is extremely difficult to determine on each strip, that's way the first column of the table gives the electric resistance of each strip. This resistance is also called “2 point resistance”, because it is measured between the two repeats of each electrical contact, at both ends of one of the strips.

This first example shows that it is possible to achieve a extremely high RF transparency with judiciously chosen values for the L1 and L2 values. More precisely, with a L1 value of 2 mm and L2 value of 2 mm, the RF transparency can reach 98% at 66 GHz (with a strip electric resistance between 3 and 4Ω, preferably 3.5Ω). This transparency achieved for the test described in the first row of the table is in particular higher than the transparency achieved during the second test associated with the second row. However, in this second test, the nanowire density is lower and the second width L2 of the inter-strip zones is higher. Intuitively, this could lead to increase the RF transparency, but the tests disclose conversely that a particular combination should be chosen for L1 and L2 values to preserve an already perfect RF transparency.

The resistive heating generated is also very satisfactory for the combination retained, since a temperature of 44° C. has been achieved with applying a 5V voltage. Incidentedly, it is noted that an increase in the voltage applied enables a rise in the surface temperature. Heating limits are however associated with the heat resistance of the plastic structures 8. For example, with a 9V voltage for the second test, the temperature switches to 60° C. instead of 40° C. obtained at 6V.

### Example 2

The second example turns out to be perfectly suitable for high distance detection sensors field for the automotive field, with an antenna operating at a frequency in the order of 77 GHz. This sensor type is particularly suitable for ACC applications.

For this second example, the operating conditions are identical to those of the first example, with the following provisos:
the RF transparency is investigated at 77 GHz.
for the two first tests, the main structure of the radome is made on an ABS 2.4 mm thickness, with an intrinsic RF transparency of 72%, whereas for the third test, the main structure of the radome is identical to that of the first test;
strips of nanowires are made with a first width L1 of 2 mm, and the inter-strip zones are first set with a second width L2 of 4.5 mm (resulting in a period P of 6.5 mm for this first test), and then the second width is set to 7.5 mm (resulting in a period P of 9.5 mm for this second test), and finally the second width is set to 5.5 mm (resulting in a period P of 7.5 mm for this third test).

The results of these tests are given in the table below.

| Strip | | Period | | |
|---|---|---|---|---|
| resistance | Widths L1-L2 | P | RF transparency | Temperature |
| (Ω) | (mm-mm) | (mm) | (at 77 GHz) (%) | obtained (° C.) |
| 9.4 | 2-4.5 | 6.5 | 97 | 40 (at 10 V) |
| 10.2 | 2-7.5 | 9.5 | 95 | 45 (at 12 V) |
| 8.5 | 2-5.5 | 7.5 | 98 | 42 (at 9 V) |

This second example also shows that it is possible to achieve an extremely high RF transparency with judiciously chosen values for L1 and L2 values, and for a main structure of a given nature. More precisely, with a L1 value of 2 mm and L2 value between 4 and 5 mm, preferably 4.5 mm, the RF transparency can reach 97% at 77 GHz (with a strip electric resistance between 9 and 10Ω, preferably 9.5Ω). This RF transparency obtained during the test described in the first row of the table is in particular higher than the RF transparency obtained during the second test associated with the second row. However, during this second test, the nanowire density is lower and the second width L2 of the inter-strip zones is higher. Intuitively, this could result in increasing the RF transparency, but the tests disclose reversely that there is a particular combination for L1 and L2 values enabling an already perfect RF transparency to be preserved.

The resistive heating generated is also very satisfactory for the combination retained, because a 40° C. temperature has been achieved with applying a 10V voltage.

In the same way, with the different main structure retained for the third test, the most satisfactory combination resides in a L1 value of 2 mm and a L2 value between 5 and 6 mm, preferably 5.5 mm. The RF transparency can thereby reach 98% at 77 GHz (with a strip electric resistance between 8 and 9Ω, preferably 8.5Ω). The resistive heating generated is also very satisfactory for the combination retained, since a 42° C. temperature has been achieved with applying a 9V voltage.

Of course, various modifications could be brought by those skilled in the art to the invention just described, only by way of non limiting examples.

What is claimed is:

1. A radome (4) for protecting an antenna (2) capable of radiating and/or sensing radio waves in a given frequency range ranging from 3 MHz to 300 GHz, said radome being equipped with a heating system (10) comprising two electrical contacts (14, 16) between which resistive heating elements (12) are arranged,
characterised in that said resistive heating elements (12) are parallel strips spaced apart from one another and each having two ends respectively connected to both electrical contacts (14, 16), each of the strips (12) being made using a network of nanoelements including metal nanowires (18),
and in that the strips (12) have a first width (L1) strictly lower than half the length (λ) of the radio wave radiated/sensed by the antenna, and in that the period (P) at which the strips (12) succeed each other is substantially equal to the product n·λ, with (n) corresponding to a positive integer preferably different from 1.

2. The radome according to claim 1, characterised in that it has a transparency to radio waves, in said given range, higher than 50%, and more preferentially higher than 70%.

3. The radome according to claim 1, characterised in that it has an overall transmittance higher than 60% in the visible spectrum, and more preferentially between 70 and 90%.

4. The radome according to claim 1, characterised in that said nanoelements (18) are silver and/or copper and/or nickel and/or gold-based.

5. The radome according to claim 1, characterised in that the strips (12) have a first width (L1) identical for each strip, and in that they are separated by inter-strip zones (22) having a second width (L2) identical for each inter-strip zone, the ratio of the second width (L2) to the first width (L1) being higher than or equal to 1.

6. The radome according to claim 5, characterised in that the first width (L1) is between 0.5 and 3 mm, and preferably in the order of 2 mm.

7. The radome according to claim 5, characterised in that the second width (L2) is between 4 and 10 mm.

8. The radome according to claim 5, characterised in that:
each strip (12) has an electric resistance between 3 and 4Ω;
the first width (L1) is about 2 mm; and
the second width (L2) is about 2 mm.

9. The radome according to claim 5, characterised in that:
each strip (12) has an electric resistance between 8 and 10Ω;
the first width (L1) is about 2 mm; and
the second width (L2) is between 4 and 6 mm.

10. The radome according to claim 1, characterised in that it has a main structure (8) on which the heating system (10) is deposited, said main structure having an intrinsic transparency to radio waves, in said given range, higher than 70%.

11. The radome according to claim 1, characterised in that the main structure (8) is made of poly(ethylene naphthalate) or in acrylonitrile butadiene styrene.

12. The radome according to claim 1, characterised in that it is coated with an anti-scratch and/or heat conduction layer.

13. An assembly (1) comprising an antenna (2) capable of radiating and/or sensing radio waves in a given frequency range ranging from 3 MHz to 300 GHz, and a radome (4) according to claim 1.

14. The assembly according to the claim 13, characterised in that the radome (4) is arranged such that its strips are parallel to the direction of polarisation of the antenna (2).

15. The assembly according to claim 13, characterised in that the antenna (2) is designed to radiate and/or sense radio waves of 24 GHz, 60 GHz or 77 GHz.
